(19) United States
(12) Patent Application Publication
(10) Pub. No.: US 2024/0190236 A1
(43) Pub. Date: Jun. 13, 2024

(54) ARCHITECTURE FOR A HYBRID VEHICLE

(71) Applicant: MORAND CARS SA, Vuadens (CH)

(72) Inventor: Benoît MORAND, Marsens (CH)

(21) Appl. No.: 18/554,909

(22) PCT Filed: Apr. 12, 2022
(86) PCT No.: PCT/IB2022/053402

§ 371 Date: Oct. 11, 2023

(30) Foreign Application Priority Data
Apr. 12, 2021 (CH) 00372/21

(51) Int. Cl. B60K 6/442; B60K 6/26; B60K 6/28; B60K 6/36; B60K 6/405

(52) U.S. Cl. CPC B60K 6/442; B60K 6/28; B60K 6/36; B60K 6/26; B60K 6/405

(57) ABSTRACT

Disclosed is a hybrid vehicle including a mechanical subsystem and an electrical subsystem, wherein the electrical subsystem includes an electrical storage device, at least one electrical motor fed by the electrical storage device and at least one inverter associated to each of the at least one electrical motor. The hybrid vehicle further includes a command unit adapted to modulate the driving force provided to each of the wheels by the mechanical subsystem and by the electrical subsystem according to predetermined parameters. Also disclosed is a method of managing the electrical power of the hybrid vehicle, including the step of charging the electrical storage device in less than 5 minutes.

### TECHNICAL DOMAIN

The present invention concerns the architecture of a hybrid vehicle, in particular for a hybrid hypercar, or racing car, comprising a combination of one or more electrical motor and a combustion engine. It relates in particular to the powertrain architecture of such a hybrid car. The present invention further relates to the management of the power sources of a hybrid car having an electrical source and a thermal source of energy.

### RELATED ART

Racing cars are more and more facing limitations in terms of energy consumption and energy efficiency. Hybrid technologies are increasingly implemented in commercial vehicles. They represent an encouraging opportunity to improve the performances of the race cars, in particular regarding the recovering of the energy during the braking phases. The commercial cars having hybrid architecture, however, also suffer from limitations, in terms of autonomy, power management, speed of charge, for example. Such limitations may refrain consumers to buy hybrid vehicles. This can be prejudicial to the current objective of saving fossil energies.

There is thus currently a great challenge to develop high performance technologies allowing the use of electrical energy combined to a traditional engine. There is room for improvement of such technologies, in the field of the racing cars, as such, and also for more common commercial use of such hybrid vehicles. In a more general way, the mobility involving motorised vehicles, including the newly developed modes of travel, needs improved efficiency regarding the energy consumption.

### Short Disclosure of the Invention

An aim of the present invention is the provision of a hybrid architecture for a vehicle, that overcomes the above-mentioned shortcomings and limitations. In particular, it is an aim of the present invention to improve the flexibility of use of a hybrid vehicle.

Another aim of the present invention is to provide a hybrid architecture for a vehicle adapted to deliver a large amount of electrical energy for a short time. It is in particular an aim to deliver a large amount of electrical energy in addition to, or in replacement of, a mechanical energy, for a short period of time. The claimed hybrid architecture thus aims at either limiting the polluting exhausts from a combustion engine or temporarily increasing driving power or both.

Another aim of the present invention is to provide an hybrid architecture for a vehicle which does not increase the global weight or which limits the weight increase of the vehicle compared to a traditional hybrid vehicle. It is in particular an aim of the present architecture to avoid or limit the weight increase related to slow release electrical energy devices.

An aim of the present invention is to provide a vehicle equipped with a hybrid architecture efficient to provide temporary high level of electrical power and/or limit the polluting exhausts of a combustion engine. In particular such a hybrid vehicle.

Another aim of the invention is to provide an improved method of management of the electrical source of such a hybrid vehicle. More particularly, it is aimed at managing the electrical power in combination with the thermal system of the vehicle.

According to the invention, these aims are attained by the object of the attached independent claims, further defined in the dependent claims.

A vehicle according to the present description denotes any motorized vehicles such as a car, a truck, a bus or equivalent vehicle. It denotes for example a sport car, or a racing car, also called a supercar, or sometimes a hypercar, due to its improved power and performances. The architecture and method here described is also applicable to urban vehicles, either individual, or receiving publics, or cargo vehicles delivering merchandises at several different points through the cities. Vehicles also denotes aeroplanes, helicopters or any other flying vehicles. It also denotes boats, or any related floating vehicle. It also relates to unmanned vehicles such as drones, exploration robots or any related remote-controlled vehicles. The hybrid architecture and method here described can be dedicated to the propulsion of the vehicle, through wheels, helices, caterpillars, turbines or any other means. The hybrid architecture and method can in addition or alternatively be dedicated to motorised accessories onboard such as articulated arms, of an excavator for example, or cranes or any other tool. It can be for example a farm tractor or a construction machine adapted to drive a variety of tools. Such motorised accessories may be directly driven by the hybrid architecture and method of the present description or through an intermediate device such as a hydraulic pump, an air compressor, or any suitable arrangement.

### SHORT DESCRIPTION OF THE DRAWINGS

Exemplar embodiments of the invention are disclosed in the description and illustrated by the following drawings:

FIG. 1: Schematical representation of a hybrid vehicle according to the present disclosure.

FIG. 2: Schematical representation of the management of the power sources.

### EXAMPLES OF EMBODIMENTS OF THE PRESENT INVENTION

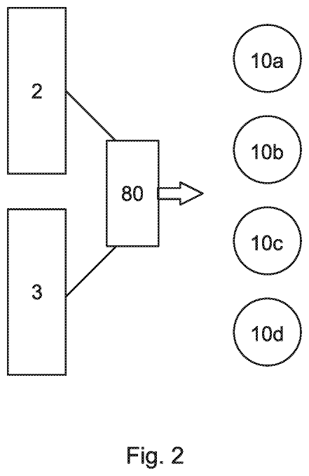

With reference to FIG. 2, the exemplified vehicle 1 according to the present disclosure comprises a powertrain architecture having a mechanical subsystem 2 and an electrical subsystem 3. Each one of the mechanical subsystem 2 and the electrical subsystem 3 comprises a dedicated source of energy. Each one of the mechanical subsystem 2 and the electrical subsystem 3 can be used independently from one another to move the vehicle so as to allow either a full mechanical propulsion or a full electrical propulsion of the vehicle 1. The mechanical subsystem 2 and the electrical subsystem 3 can in addition work concomitantly to deliver a mixt driving force to the wheels 10a, 10b, 10c, 10d of the vehicle 1. Each wheel or some of the wheels of the vehicle 1 can receive a driving force exclusively provided by the mechanical subsystem 2, by the electrical subsystem 3 or by both mechanical 2 and electrical 3 subsystems in a variable ratio. A command unit 80 is adapted to manage the origin of the power source and properly dispatch it to the wheels.

Different modes can be selected, either manually or automatically.

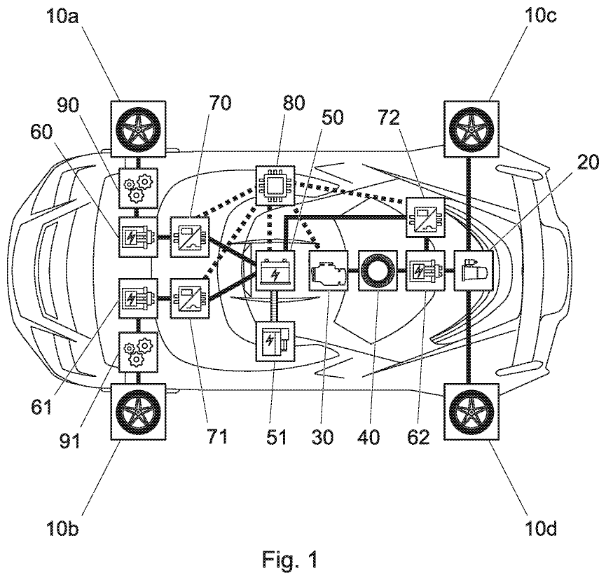

With reference to FIG. 1, the mechanical subsystem 2 comprises an internal combustion engine 30 as a source of energy, fed from a tank of carburant (not represented). The internal combustion engine 30 is connected to two or more wheels of the vehicle 1 through a gearbox 20 and a clutch 40. The two wheels 10c, 10d of the rear axle can for example be coupled to the internal combustion engine 30. Alternatively, the two front wheels 10a, 10b of a front axle can be connected to the internal combustion engine 30. Alternatively, all the wheels 10a, 10b, 10c, 10b can be connected to the internal combustion engine 30 so as to provide a four-driving wheel vehicle, wherein all the driving wheels are driven by the internal combustion engine 30. Like in known powertrains, the clutch 40 allows to disconnect the internal combustion engine 30 from the driving wheels and reconnect it. The gearbox 20 allows the selection of the proper gear reductions. Any type of gearbox can be used according to the needs, such as a 6-speed or 7-speed or 8-speed gearbox. As an example, a 7-speed gearbox like the XTRAC P1192 can be selected.

The internal combustion engine 30 may be of any type, including natural aspirated, turbocharged, 4 or 2 strokes and Wankel. It may be adapted to any type of fuel including petrol, synthetic, hydrogen, natural gas and biofuel. It can be of any size such a 4 cylinders or 6 or 8 or 10 or 12 cylinders. As an example, the internal combustion engine may be a BMW V10 MODEL S85B50, naturally aspirated, 90°, 5.0 L, petrol engine.

The hybrid vehicle 1 also comprises a brake system, allowing to brake each of the wheels 10, with the necessary activation means. Such activation means are similar to the brake system usually implemented in a vehicle propelled by an internal combustion engine. It is for example activated by means of a hydraulic pressure when the driver presses the brake pedal. The brake system of the vehicle 1 can be designed so as to brake all the wheels of the vehicle 1, including the wheels not connected to the internal combustion engine 30. Alternatively, the brake system of the vehicle 1 can be designed to break only some wheels of the vehicle, the other wheels being braked by another system, such as an electrical subsystem. The brake system of the vehicle 1 does not exclude that one or more wheels of the vehicles normally braked by the brake system can also be braked by another system such as an electrical subsystem.

The electrical subsystem 3 comprises an electrical storage device 50 wherein the electrical energy is stored. Such electrical storage device may be of any suitable type. For example, it can comprise one or several chemical batteries or battery cells. Such chemical batteries or battery cells can be lithium-ion batteries, or graphene batteries, or lead-acid batteries. The electrical storage energy can alternatively or in addition comprise fuel cells. It can alternatively or in addition comprise one or more capacitor such as ultracapacitor, hybrid capacitor or lithium capacitor. The electrical storage device 50 preferably weights around 100 kg or less. The voltage of the electrical storage device 50 is preferably higher than 300 V, more preferably equal or higher than 400 V. Depending on the use of the vehicle 1, the voltage of the electrical storage device 50 can be equal or higher than 600 V or 800 V. The electrical storage device 50 is adapted to provide an output power of at least 150 KW, preferably at least 200 kW. For example, it can deliver an output power comprised between around 200 kW and around 250 kW for a continuous consumption of 25 seconds. The electrical storage device 50 is adapted to provide a peak output power of at least 200 kW, preferably at least 250 kW. For example, it can deliver a peak output power comprised between around 250 KW and around 300 kW for a peak consumption of 10 seconds. The electrical storage device 50 is adapted to store an electrical energy of around 3 to 8 kWh, such as between 4 to 6 kWh or around 5.5 kWh. The electrical storage device 50 is preferably designed to receive an input power of at least 200 kW, preferably at least 300 kW. The input power can thus be more than 30 times, preferably more than 50 times, or even 100 times or more of the stored energy of the electrical storage device 50. This is independent on the number of cells. This allows a very fast charge. As it will be better described below, the electrical storage device 50 can be charge by means of an external source of power supply. It can also be charge by an internal element of the vehicle 1 such as the internal combustion engine 30 or the brake system, or any other suitable internal element.

As an example, the electrical storage device can comprise 2 modules of 48 HUC cells each, wherein the cells are of type H60W-4R2-0018 from SECH. It is however understood that more than two modules can be used, in parallel.

It is understood that while any type of electrical storage device 50 can be envisaged, the electrical storage device 50 having the highest input power and/or the highest peak output power will be preferred for race cars. This allows to provide sufficient energy for a fast acceleration. It also allows fast charge during intense periods of braking or high acceleration of the internal combustion engine 30.

In an embodiment, the electrical storage device 50 excludes the traditional batteries adapted to slowly release electrical energy along a pathway so as to maintain a great electrical autonomy. Such kind of batteries are not adapted to deliver a large amount of electrical energy on a short time. A short time typically denotes a time frame of few seconds to few minutes. Such a short time corresponds for example to the time of acceleration of the vehicle from an initial speed of 0 km/h or less than few dizains of km/h such as 30 to 60 km/h until a high speed of 100 or 150 km/h or higher.

The electrical subsystem 3 further comprises at least one electrical motor 60, 61, 62 fed by the storage device 50. Such an electrical motor can be connected to the two wheels of the rear axle. Alternatively, or in addition an electrical motor can be connected to the wheels of a front axle.

The electrical motor, or the electrical motors may be selected among any type according to the needs, being brushless or not. In case several electrical motors are present, they can be all the same or not.

An electrical motor can be connected to the same wheels as the internal combustion engine 30. For example, both the internal combustion engine 30 and an electrical motor 62 can be connected to the two wheels 10c, 10d of the rear axle. In case the internal combustion engine 30 is connected to the two wheels 10a, 10b of the front axle, an electrical motor can also be connected to the same wheels 10a, 10b.

According to an embodiment, the hybrid vehicle 1 comprises a rear axle and a front axle, wherein the internal combustion engine 30 is connected to one or both of the rear axle and the front axle, and at least one electrical motor 62 is connected to one of the front and rear axles. Alternatively, the internal combustion engine is connected to only one axle and one electrical motor is connected to only one axle, either the same axle as the internal combustion engine 30 or the other one.

According to another embodiment, the hybrid vehicle 1 comprises only one axle, preferably a rear axle, wherein the corresponding wheels 10c, 10d are concomitantly driven. The other wheels can be independently driven by a dedicated electrical motor 60, 61 or not. The wheels 10c, 10d of a same axle can be exclusively driven by the internal combustion engine 30. Alternatively, the axle connected to the internal combustion engine 30 can also be connected to an electrical motor 62 so as to drive the corresponding wheels 10c, 10d with the internal combustion engine 30 or with the electrical motor 62 or both. Under such an arrangement, the two wheels 10a, 10b, which are not part of an axle, can be independently and exclusively driven by two electrical motors 60, 61. Preferably, the two front wheels 10a, 10b, are not part of an axle and independently driven by a dedicated motor 60, 61.

According to a preferred embodiment, the hybrid vehicle 1 comprises a rear axle having two wheels 10c, 10d concomitantly driven by the internal combustion engine 30. The rear axle is in addition connected to a electrical motor 62. The front wheels 10a, 10b are each independently driven by a dedicated electrical motor 60, 61. The choice of the electrical motors 60, 61, 62 are thus adapted accordingly. For example, the electrical of the front wheels 10a, 10b can be an EMPEL SYSTEMS EM200 or EM250 or an INTEGRAL POWERTRAIN SPM242-94. The electrical motor 62 connected to the rear axle can be an EMPEL SYSTEMS EM150, or an INTEGRAL POWERTRAIN SPM177-91.

For wheels which can be propelled by both the internal combustion engine 30 and an electrical motor 62, the corresponding electrical motor can be directly connected to the crankshaft between the internal combustion engine 30 and the clutch 40. Under such configuration, the clutch 40 allows to disconnect both the internal combustion engine 30 and the motor 62 from the corresponding wheels 10c, 10d. Alternatively, the electrical motor 62 can be arranged between the clutch 40 and the corresponding wheels, so that only the internal combustion engine 30 is disconnected from the corresponding wheels 10c, 10d when the clutch 40 is activated.

The electrical subsystem 3 further comprises one or several invertors 70, 71, 72, each one being connected to the electrical storage device 50 and to an electrical motor 60, 61, 62. Each invertor 70, 71, 72 is adapted to activate the corresponding electrical motor 60, 61, 62, by supplying to it the electrical energy from the electrical storage device 50. Each invertor 70, 71, 72 is also adapted to transmit energy retrieved from the corresponding wheels to the electrical storage device 50. For example, when electrical power is no longer fed to a given electrical motor, while the hybrid vehicle 1 is still moving, the corresponding wheels can transmit kinetic energy through the electrical motor so as to charge the electrical storage device 50. In other words, the electrical motors of the electrical subsystem 3 can be used to brake or slow down the wheels or some wheels of the hybrid vehicle 1, while the electrical motors allow the charging of the electrical storage device 50. A motor can charge the electrical storage device not only during the braking of the hybrid vehicle 1. For example, an electrical motor 62 placed on the crankshaft of the internal combustion engine 30 can also allow charging the electrical storage device 50, when the internal combustion engine 30 is running. This can be done at idle state of the hybrid vehicle 1. It can also be done when the internal combustion engine 30 drives the vehicle, wherein an extra torque is used to activate the electrical motor 62 and thus charge the electrical storage device 50.

The electrical subsystem 3 further comprises a plugging device 51 allowing to connect the electrical storage device 50 to an external source of power supply.

For wheels 10a, 10b, which are not part of an axle and independently driven by an electrical motor 60, 61, the electrical motor 60, 61 can be directly linked to the corresponding wheel 10a, 10b so as to drive it. The speed of rotation of the wheel is thus proportional the speed of rotation of the electrical motor to which it is linked.

Alternatively, for wheels 10a, 10b which are not part of an axle and independently driven by an electrical motor 60, 61, a gear reduction 90, 91 can be arranged between the wheel and the corresponding electrical motor. Such gear reductions allow to modulate the speed of rotation of the wheel with respect to the speed of rotation of the corresponding motor, by selecting a suitable gear reduction. The selection of a suitable gear reduction is preferably done automatically based on one or several predetermined parameters such as the speed of the vehicle 1, the speed of rotation of the electrical motors 60, 61 and the electrical energy consumption. Any type of gear reduction can be used according to the specific needs. For example, the front transmission, comprising gear reductions can be a HEWLAND GEVT-200 or a XTRAC P1320.

Although the mechanical subsystem 2 and the electrical subsystem 3 can independently move the hybrid vehicle 1, they are synchronised by a suitable command unit 80. The command unit 80 can be for example an ECU or any other device adapted to activate or deactivate selected elements of the subsystems according to predetermined parameters. The command unit 80 allows for example to independently activate and deactivate the electrical motors 60, 61, 62 through their corresponding inverter 70, 71, 72. The command unit 80 further allows to determine the amount of energy that should be supplied to the electrical motors 60, 61, 62. This is done at any instant of the move of the hybrid vehicle 1, based on parameters such as the position of the throttle, the position of the brake pedal, the speed of the hybrid vehicle 1, the trajectory of the vehicle 1, and any other suitable parameter. In addition, the command unit 80 may receive information from one or several sensors adapted to detect slippage of the wheels, blockage of the wheels, trajectory deviations of the vehicle, and any other sensors involved in the survey of the behaviour of the vehicle 1. The command unit 80 may automatically adapt the activation of one or several electrical motors 60, 61, 62, or the selection of gear reductions 90, 91 when applicable. For example, an electrical motor may be automatically stopped or slow down in case of slippage of the corresponding wheel or to correct the trajectory of the vehicle.

When piloting the electrical subsystem 3 and its elements, the command unit 80 may in addition consider other parameters such as the state of charge of the electrical storage device 50, the selected driving mode including a full electrical driving mode, a full thermal driving mode and a mitigated driving mode.

The command unit 80 is also adapted to pilot the internal combustion engine 30 or some of its functions. For example, it can adapt the driving force delivered by the internal combustion engine 30 to the driven wheels based on the position of the throttle. The command unit 80 may also automatically activate the braking system upon sensing a slippage of one or more wheels or a deviation of the trajectory of the vehicle 1.

The command unit 80 also allows to equilibrate or optimize the driving force delivered by the mechanical subsystem 2 and by the electrical subsystem 3. For example, the driving force delivered by the electrical subsystem 3 can be automatically increased upon a strong acceleration of the vehicle 1, when the throttle pedal is pressed above a predetermined threshold. This allows to punctually deliver the requested power for a better acceleration. At idle state, or when the vehicle 1 is slowing down, the command unit 80 can automatically recharge the electrical storage device 50 by the means of one or more electrical motors 60, 61, 62.

The optimization or equilibration of the driving force may also depend on a preselected driving mode. A fully thermal driving mode can be preselected so that the electrical subsystem 3 is not activated. Under such conditions, the command unit 80 does not provide any command to the electrical motors 60, 61, 62 or a limited number of commands, which can be related to safety conditions. The fully thermal may be manually preselected. Alternatively, the fully thermal mode may be automatically selected upon certain conditions such as a very low state of charge of the electrical storage device 50, for example below a predetermine threshold. It can also be selected when certain driving conditions are detected, such as a prolongated constant speed or any other driving conditions so that the electrical storage is preserved. Even though a fully thermal mode is preselected, the command unit 80 may automatically activate the electrical subsystem 3 under certain conditions such as a fast change of the driving conditions. For example, a fast acceleration, triggered by pressing the throttle pedal above a predetermined threshold, can induce the automatic activation of the electrical subsystem 3 or elements thereof, even under a fully thermal mode. Also, in case of a strong braking phase, the command unit 80 can trigger the charging of the electrical storage device 50.

Another preselected mode is the fully electrical mode, wherein the internal combustion engine 30 is disconnected from the corresponding driven wheels. The gearbox can be on neutral position for example. The internal combustion engine 30 may still run at an idle state, without being in a state to drive the wheels. The internal combustion engine 30 can thus still maintain the braking system or any other systems of the hybrid vehicle 1. Under the fully electrical mode, some or all of the wheels of the hybrid vehicle 1 are driven by electrical motors 60, 61, 62. For example, in case the rear wheels 10c, 10d are connected to an electrical motor 62, they can be exclusively driven by this electrical motor 62. In case the front wheels 10a, 10b and the rear wheels 10c, 10d, can be driven by an electrical motor 60, 61, 62, either the rear wheels 10c, 10d, or the front wheels 10a, 10b or both the front wheels and the rear wheels can be driven by the corresponding electrical motors 60, 61, 62. The ratio of the electrical power supplied to the front and to the rear wheels can be automatically managed by the command unit 80 according to predetermined parameters, such as the acceleration rate, the speed or the trajectory of the vehicle 1. The electrical power can thus be equally dispatched between the four wheels 10a, 10b, 10c, 10d of the vehicle 1. Alternatively, the command unit 80 may allow to deliver more power to the front wheels 10a, 10b or more power to the rear wheels 10c, 10d. The distribution of the electrical power can be adapted in real time according to the variations of speed, acceleration or trajectory of the hybrid vehicle 1. The full electrical mode does not exclude that the internal combustion engine 30 can charge the electrical storage device 50, for example when the vehicle is no longer in movement, at a stop.

A hybrid mode can alternatively be selected, either manually or automatically. Under such hybrid mode, both mechanical 2 and electrical 3 subsystems are concomitantly active and managed by the command unit 80. The driving force delivered by the two mechanical 2 and electrical 3 subsystems is managed on real time according to the several preselected parameters such as the driving style, such as a sportive style, urban style, race style, the available electrical power, the safety conditions, and any relevant parameter.

It is thus understood that the command unit 80 comprises the necessary read only memory adapted to store data, threshold values of parameters, predefined programs or software, or a combination thereof. It further comprises memory and receiving means adapted to receive data from sensors, input commands such as the throttle or the brake pedal, or any other element of the vehicle 1. The command unit 80 further comprises computing means adapted to compute the received data according to the stored programs or software. It further comprises the necessary communication means adapted to deliver instruction to at least some elements of the mechanical and electrical subsystems above described.

The electrical storage device 50 may be arranged in a protective housing (not represented). Such a protective housing is adapted to respond to the safety requirements, which may depend on specific regulations. It is also adapted to preserve the performances of the hybrid vehicle 1. As such its weight is maintained low to limit the extra-weight of the global architecture. For example, the protective housing is preferably below 2 kg or below 1 kg, even below 500 g. It preferably encapsulates the entirety of the electrical storage device 50 so as to protect it against shocks, in particular during crashes or collisions. To this end, it may comprise reinforcement elements such as metallic or polymeric traverses. The reinforcement elements may be for example local overthickness of the materials constituting the protective housing. Beside a limited overweight, the protective housing is adapted to maintain the temperature of the electrical storage device 50 in an acceptable range under all circumstances. Necessary spaces between the electrical storage device 50 and the protective housing can be arranged so as to allow an air circulation. In addition, through holes may be provided on one or several opposite sides of the protective housing to allow fresh external air to circulate around the electrical storage device 50. In addition, active means such as one or more fans can be included to the walls of the protective housing. A heater may also be included to maintain the electrical storage device 50 above allow temperature threshold to preserve the optimal performances of the electrical subsystem 2. This provides an advantage for starting phases during winter for example. Additional through holes necessary for the electrical connections are also arranged as necessary.

The protective housing may provide one unique volume adapted to receive the entirety of the electrical storage device 50. Alternatively, it can comprise several compartments each adapted to receive one electrical module of the electrical storage device 50. The command unit 80 may be lodged in the protective housing either together with the electrical storage device 50 or in a separated dedicated compartment.

The protective housing is further adapted to preserve from leakage of potential electrolytes or fluids contained in the electrical storage device 50. The through holes are preferably arranged at a upside of the housing, maintaining the bottom side, at least the half bottom side or the two-third bottom side of the housing free of any holes.

The protective housing is further resistant to fire, to protect the electrical storage device 50 from an external fire, and to contain a potential fire within the protective housing, thus preventing its propagation. The material of the protective housing is thus preferably nonorganic. To this extend It may comprise non-flammable polymers or metallic fibres, or glass fibres.

The protective housing further provides a protection against electrical leakage, and thus prevents from parasites and electrical interferences with other electrical equipment on board, in particular with the command unit 80, if arranged nearby. This also prevents from electrical damages to the users during their interventions to the vehicle.

The protective housing thus preferably complies with several or all of the safety and mechanical requirements above described. It complies in particular to the adequate mechanical requirements, fire protection requirements, electrical protection requirement, fluid leakage requirements, which may be provided through the corresponding regulations. This is preferably without impact on the global performances of the hybrid vehicle 1. The protective housing is thus preferably made or comprise light and resistant materials such as carbon fibres, glass fibres, inorganic polymers or fabrics, composite materials, polymer resins and a mixture thereof. Examples of materials are for example those of the company BCOMP.

The present disclosure further relates to a method of managing the energy of a hybrid vehicle 1, as described here. In particular, the method comprises a step of selecting a driving mode among a full electrical driving mode, a full thermal driving mode and a hybrid mode above described. The selection can be a manual preselection. This does not exclude that an automatic selection of a more suitable driving mode occurs under specific conditions above exemplified.

The method according to the present disclosure may comprise a step of selecting a driving style among predetermined different styles. Driving styles may be defined according to parameters such as the behaviour of the driver, parameters sensed by sensors of the vehicle, or by any other parameters. A driving style may be selected among an economical style, a urban style, a cruise style, a sportive style, a race style and any other predetermined driving styles. Depending on the selected driving style, the ratio of electrical and thermal energy delivered to the wheels of the vehicle 1 can be modulated. For example, the economical style or the urban style may privilege a long autonomy of the electrical storage device 50 by charging it at stops and during the braking phases. On contrary, a sportive style preferably delivers a higher electrical power during the acceleration phases. driving conditions such as slipping roads or mountain pathways can also help determining a driving style. Driving styles may be selected manually or automatically.

The present method comprises the step of determining the remaining available electrical power stored in the electrical storage device 50. In case the available electrical energy is below a predetermined threshold, a driving mode may be privileged, such as a hybrid driving mode or full thermal driving mode. Alternatively or in addition, driving modes may be forbidden such as a fully electrical mode. In addition, some driving styles may be privileged, such as the economical driving style, wherein the mechanical subsystem 2 is used for charging the electrical storage device 50 at every time it is possible. Alternatively or in addition, driving style may be forbidden such as the sportive or race driving styles, highly demanding for the electrical subsystem 3. In case the power level of the electrical storage device 50 becomes low, the driving mode or the driving style, or both may be automatically switched to a more favourable driving mode and/or driving style.

The present method includes the steps of charging the electrical storage device 50. Preferably, the time for recharging is lower than few minutes, such as lower than 5 minutes or even lower than 2 minutes, or within 10 to 60 seconds. In other words, the input power during the charging step can be more than 30 times, preferably more than 50 times, or even 100 times or more of the stored energy of the electrical storage device 50. The charging step may be performed through the plugging device 51 and an external power supply. Alternatively, the charging step may be fully completed through the internal combustion engine 30.

Although a 4 wheels-car is here described in detail, this is not intended to limit the scope of the present hybrid architecture and method to those specific vehicles. For example, the energy used to drive the helix or helices of a boat can obey the same or similar rules related to the ratio of electrical and thermal energy delivered to the helices. High level of electrical energy may be punctually delivered under demanding circumstances such as manoeuvres or degraded weather conditions, with strong wind and waves. Some running modes equivalent to the driving mode and the driving style above describe may be selected, involving specific parameters. Also, for on board accessories such as cranes, high level of energy may be requested to lift a charge, while energy retrieval can be set up when moving down charges. The same or similar energy management can be used for other applications.

1. A hybrid vehicle comprising a mechanical subsystem and an electrical subsystem, wherein the mechanical subsystem comprises an internal combustion engine, a gearbox and a clutch, allowing to deliver a driving force to two or more wheels, and wherein the electrical subsystem comprises an electrical storage device, at least one electrical motor fed by the electrical storage device and at least one inverter associated to each of the at least one electrical motor, said at least one electrical motor being adapted to deliver a driving force to one or more wheels of the hybrid vehicle, wherein each one of the mechanical subsystem and the electrical subsystem can be used independently from one another so as to allow either a full mechanical propulsion, a full electrical propulsion or a mixt driving force to the hybrid vehicle, the hybrid vehicle further comprising a command unit adapted to modulate the driving force provided to each of the wheels by the mechanical subsystem and by the electrical subsystem according to predetermined parameters, being adapted to automatically distribute the energy to the wheels according to a full electrical mode, a full thermal mode or a hybrid mode, wherein said electrical storage device comprises one or more capacitors and is free of traditional batteries.

2. The hybrid vehicle according to claim 1, wherein said vehicle comprises a rear axle having two wheels said rear axle being connected to the internal combustion engine through the gearbox and the clutch and being further connected to one of said at least one electrical motor.

3. The hybrid vehicle according to claim 2, wherein said electrical motor is arranged between the internal combustion engine and the clutch or between the clutch and the gearbox.

4. The hybrid vehicle according to claim 1, wherein the front wheels are each independently driven by one of said electrical motors.

5. The hybrid vehicle according to claim 4, further comprising one or more gear reductions arranged between said electrical motors and the corresponding wheels.

6. The hybrid vehicle according to claim 2, wherein the electrical motor connected to the rear axle is selected among an EMPEL SYSTEMS EM150, or an INTEGRAL POWERTRAIN SPM177-91, and wherein the electrical motors driving the front wheels are selected among an EMPEL SYSTEMS EM200 or an EM250 or an INTEGRAL POWERTRAIN SPM242-94.

7. The hybrid vehicle according to claim 1, wherein said at least one inverter is adapted to supply electrical power from the electrical storage device to the electrical motor to which it is connected and to charge the electrical storage device retrieved from said electrical motor.

8. The hybrid vehicle according to claim 1, further comprising a plugging device allowing to connect the electrical subsystem to an external source of power.

9. (canceled)

10. The hybrid vehicle according to claim 1, wherein said command unit, when said vehicle is in a hybrid mode, is adapted to automatically adapt or modulate the ratio of energy originating from the electrical subsystem and the mechanical subsystem to each of the wheels.

11. The hybrid vehicle-according to claim 1, further comprising a protective housing, receiving one or more of the electrical storage device and the command unit, said protective housing being made of, or comprising materials selected from carbon fibers, glass fibers, inorganic polymers or fabrics, composite materials, polymer resins and a mixture thereof.

12. The hybrid vehicle according to claim 1, said storage device comprising or consisting of an electrical energy storage device adapted to deliver an output power comprised between around 200 kW and around 250 KW for a continuous consumption of 25 seconds.

13. The hybrid vehicle according to claim 1, said storage device comprising or consisting of an electrical energy storage device adapted to deliver a peak output power comprised between around 250 kW and around 300 kW for a peak consumption of 10 seconds.

14. The hybrid vehicle according to claim 1, said storage device comprising or consisting of an electrical energy storage device adapted to receive an input power during its charging step of more than 30 times or 50 times, or 100 times or more of its stored energy or storable energy so as to allow a time of charge lower than 5 minutes.

15. Method of managing the electrical power of a hybrid vehicle as defined claim 1, comprising the step of determining the available level of electrical energy in the electrical storage device and one or more of the steps of selecting a driving mode and selecting a driving style.

16. The method according to claim 15, further comprising the step of charging the electrical storage device, wherein the charging is accomplished in less than 5 minutes.

17. The hybrid vehicle according to claim 2, wherein the front wheels are each independently driven by one of said electrical motors.

18. The hybrid vehicle according to claim 17, wherein the electrical motor connected to the rear axle is selected among an EMPEL SYSTEMS EM150, or an INTEGRAL POWERTRAIN SPM177-91, and wherein the electrical motors driving the front wheels are selected among an EMPEL SYSTEMS EM200 or an EM250 or an INTEGRAL POWERTRAIN SPM242-94.

19. The hybrid vehicle according to claim 18, wherein said at least one inverter is adapted to supply electrical power from the electrical storage device to the electrical motor to which it is connected and to charge the electrical storage device retrieved from said electrical motor.

20. The hybrid vehicle according to claim 19, further comprising a plugging device allowing to connect the electrical subsystem to an external source of power.

21. The hybrid vehicle according to claim 20, wherein said command unit, when said vehicle is in a hybrid mode, is adapted to automatically adapt or modulate the ratio of energy originating from the electrical subsystem and the mechanical subsystem to each of the wheels.
